(19) United States
(12) Patent Application Publication
(10) Pub. No.: US 2026/0016013 A1
(43) Pub. Date: Jan. 15, 2026

(54) SILENCING UNIT AND SILENCING STRUCTURE

(71) Applicants: Johnson Controls Air Conditioning and Refrigeration (Wuxi) Co., Ltd., Wuxi (CN); Tyco Fire & Security GmbH, Neuhausen am Rheinfall (CH)

(72) Inventors: Shengmei Yang, Wuxi (CN); Kun Lin, Wuxi (CN)

(21) Appl. No.: 18/995,053

(22) PCT Filed: Jul. 14, 2023
(86) PCT No.: PCT/US2023/027812

§ 371 Date: Jan. 15, 2025

(30) Foreign Application Priority Data
Jul. 15, 2022 (CN) 202210834871.8

(51) Int. Cl. F04C 29/06; F04C 18/16

(52) U.S. Cl. CPC F04C 29/065; F04C 18/16

(57) ABSTRACT

The present application discloses a silencing unit and a silencing structure. The silencing unit includes a main body and a neck. The main body is provided with a cavity and a liquid drain outlet, and the drain outlet is arranged on a side wall of the main body and communicates with the cavity. The neck is arranged on a side portion of the main body and connected to the main body, and the neck is provided with a drain channel. Wherein the drain channel communicates with the cavity through the drain outlet, and the bottom of the cavity is not lower than the bottom of the drain channel. The silencing unit of the present application can drain a liquid entering the cavity out of the cavity while silencing.

### TECHNICAL FIELD

The present application relates to a silencing device, and more particularly relates to a silencing unit.

### BACKGROUND ART

A silencing device can be used in a scene where silencing is required, so as to perform silencing on the scene. However, a liquid (e.g. rainwater, lubricating oil, etc.) cannot be drained after entering the silencing device, so that the silencing effect will be reduced or even lost.

### SUMMARY OF THE INVENTION

According to a first aspect of the present application, the present application provides a silencing unit, which includes a main body and a neck. The main body is provided with a cavity and a liquid drain outlet, and the drain outlet is arranged on a side wall of the main body and communicates with the cavity. The neck is arranged on a side portion of the main body and connected to the main body, and the neck is provided with a drain channel. Wherein the drain channel communicates with the cavity through the drain outlet, and the bottom of the cavity is not lower than the bottom of the drain channel.

According to the silencing unit of the first aspect of the present application, the drain channel and the cavity are formed in such a way of extending along a first direction.

According to the silencing unit of the first aspect of the present application, the bottom of the drain channel is arranged in an inclined manner.

According to the silencing unit of the first aspect of the present application, the bottom of the cavity is flush with that of the drain channel.

According to the silencing unit of the first aspect of the present application, the bottom of the cavity is higher than the bottom of the drain channel.

According to the silencing unit of the first aspect of the present application, the silencing unit further comprises a communication neck, the communication neck is arranged on a side portion of the main body and connected to the main body, the communication neck is provided with a communication channel, and the communication channel communicates with the cavity.

According to the silencing unit of the first aspect of the present application, the communication channel is formed in such a way of extending along the first direction.

According to the first aspect of the present application, the present application provides a silencing structure, which comprises a wall and at least one silencing unit described above. The wall is provided with a wall surface. An inlet of the drain channel is arranged on the wall surface.

According to a silencing structure of a second aspect of the present application, the silencing structure comprises drain channels of at least two silencing units, and volumes of cavities of the drain channels of the at least two silencing units or sizes of the drain channels are different.

According to the silencing structure of the second aspect of the present application, the wall surface is non-planar, and extending directions of the cavity of the drain channel of each of the at least one silencing unit and the drain channel are perpendicular to a tangent line at the wall surface where the cavity and the drain channel are disposed.

The silencing unit of the present application can drain a liquid entering the cavity out of the cavity while silencing.

Other features, advantages and embodiments of the present application may be set forth or become apparent by consideration of the following detailed description, accompanying drawings and claims. In addition, it should be understood that the above summaries of the invention and the following specific embodiments are all exemplary and intended to provide further explanations rather than limit the scope of the present application to be claimed. However, the detailed description and specific examples indicate only preferred embodiments of the present application. Various changes and modifications within the spirit and scope of the present application will become apparent to those skilled in the art from this detailed description.

### BRIEF DESCRIPTION OF THE DRAWINGS

The features and advantages of the present application may be better understood by reading the following detailed description with reference to the accompanying drawings, in which like reference numerals refer to like parts throughout.

FIG. 1A is a perspective view of a silencing unit according to a first embodiment of the present application;

FIG. 1B is a cross-sectional view of a silencing unit shown in FIG. 1A along a length direction;

FIG. 2A is a front view of a silencing unit according to a second embodiment of the present application;

FIG. 2B is a cross-sectional view of a silencing unit shown in FIG. 2A along a length direction;

FIG. 3A is a front view of a silencing unit according to a third embodiment of the present application;

FIG. 3B is a front view of a silencing unit according to a fourth embodiment of the present application;

FIG. 3C is a cross-sectional view of a silencing unit according to a fifth embodiment of the present application along a length direction;

FIGS. 4A-4B are partial cross-sectional views of a silencing unit according to a sixth embodiment of the present application;

FIG. 5A is a cross-sectional view of a silencing unit according to a seventh embodiment of the present application along a length direction;

FIG. 5B is a cross-sectional view of a silencing unit according to an eighth embodiment of the present application along a length direction;

FIG. 6 is a front view of a silencing unit according to a ninth embodiment of the present application;

FIG. 7 is a front view of a silencing structure composed of a silencing unit shown in FIG. 1A;

FIG. 8 is a front view of a silencing structure composed of a silencing unit shown in FIG. 6;

FIG. 9A is an example of a cutaway perspective view of a screw compressor using a silencing structure according to the present application;

FIG. 9B is another example of a cutaway perspective view of a screw compressor using a silencing structure according to the present application; and

FIG. 10 is a perspective view of a wind guide ring using a silencing structure according to the present application.

### DETAILED DESCRIPTION OF EMBODIMENTS

Various specific embodiments of the present application will be described below with reference to the accompanying drawings, which constitute a part of the specification. It should be understood that although terms, such as “front”, “rear”, “upper”, “lower”, etc., that represent directions are used in the present application to describe various example structural parts and elements of the present application, these terms used herein are determined based on example orientations shown in the accompanying drawings for ease of illustration only. Since the embodiments disclosed in the present application may be disposed in different directions, these terms that represent directions are for illustration only and should not be regarded as limiting.

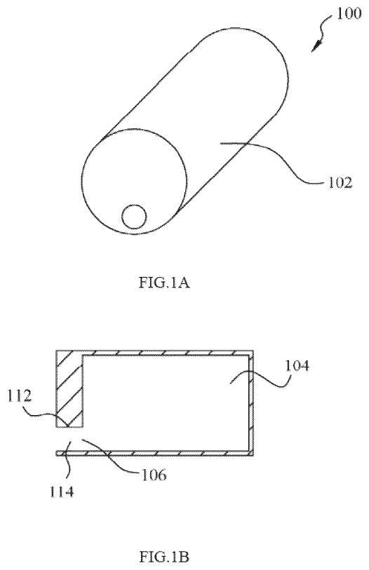

FIG. 1A is a perspective view of a silencing unit 100 according to a first embodiment of the present application, and FIG. 1B is a cross-sectional view of the silencing unit 100 shown in FIG. 1A along a length direction. As shown in FIGS. 1A-1B, the silencing unit 100 includes a main body 102 and a neck 112. The silencing unit 100 is substantially cylindrical, and has a certain length (i.e., a length along a first direction). The main body 102 and the neck 112 are also both cylindrical. The neck 112 is arranged on a side portion (e.g., front portion) of the main body 102 and connected to the main body 102. The main body 102 is provided with a cavity 104 and a drain outlet 106. The cavity 104 is substantially a cylinder formed in such a way of extending along the first direction. The drain outlet 106 is arranged on a front side wall of the main body 102 and communicates with the cavity 104. The drain outlet 106 is circular. The neck 112 is provided with a drain channel 114 formed in such a way of extending along the first direction, and the drain channel 114 is substantially cylindrical. A shape of the cross section of the drain channel 114 is the same as that of the drain outlet 106. One end of the drain channel 114 communicates with the cavity 104 through the drain outlet 106, and the other end of the drain channel 114 is a free end used for receiving sound. The bottom of the drain channel 114 is flush with the bottom of the cavity 104.

The drain channel 114 is not only used for receiving sound, but can also be used for draining liquid. Specifically, the sound can pass through the drain channel 114 from the free end of the drain channel 114 and then enter the cavity 104, thereby realizing silencing. When there is liquid in the scene where the silencing unit 100 is disposed (e.g., the silencing unit is installed outdoors and there is rainwater), even if the liquid also enters the cavity 104 from the drain channel 114, due to the effect of gravity, the liquid entering the cavity 104 will be deposited at the bottom of the cavity 104, and since the bottom of the drain channel 114 is flush with the bottom of the cavity 104, the liquid entering the cavity 104 can be drained out of the cavity 104 from the drain channel 114. In this way, the silencing effect of the silencing unit 100 can be ensured.

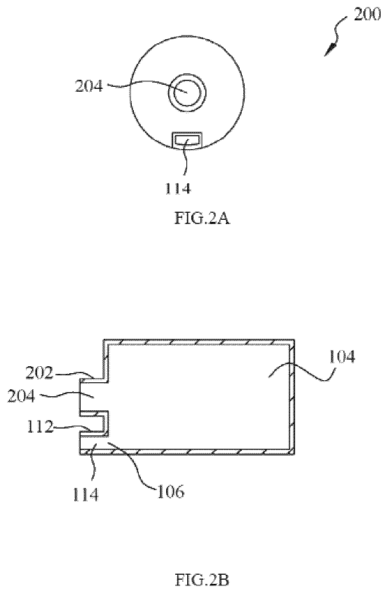

FIG. 2A is a front view of a silencing unit 200 according to a second embodiment of the present application, and FIG. 2B is a cross-sectional view of the silencing unit 200 shown in FIG. 2A along a length direction. The similarities between the silencing unit 200 shown in FIGS. 2A-2B and the silencing unit 100 shown in FIGS. 1A-1B will not be described in detail again. The differences are that first, the silencing unit 200 further comprises a communication neck 202, and second, the drain channel 114 in the silencing unit 200 is not cylindrical. Specifically, as shown in FIGS. 2A-2B, the drain channel 114 is substantially cuboid-shaped, but a lower part of the drain channel is a circular arc matched with the main body 102. The communication neck 202 is arranged on the side portion of the main body 102 and above the drain channel 114, and is connected to the main body 102. The communication neck 202 is provided with a communication channel 204. The communication channel 204 is a cylinder formed in such a way of extending along the first direction. One end of the communication channel 204 communicates with the cavity 104, and the other end of the communication channel 204 is a free end used for receiving sound. In this embodiment, the communication channel 204 is used for receiving sound, and the drain channel 114 is mainly used for draining the liquid. Specifically, the sound can enter the cavity 104 from the communication channel 204 and the drain channel 114, thereby realizing silencing. Since the bottom of the drain channel 114 is flush with the bottom of the cavity 104, the liquid entering the cavity 104 can be drained out of the cavity 104 from the drain channel 114.

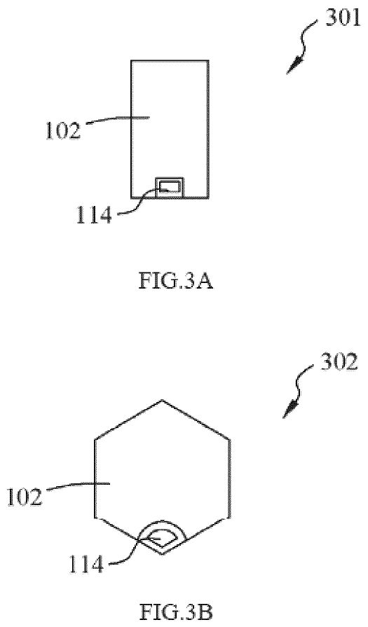

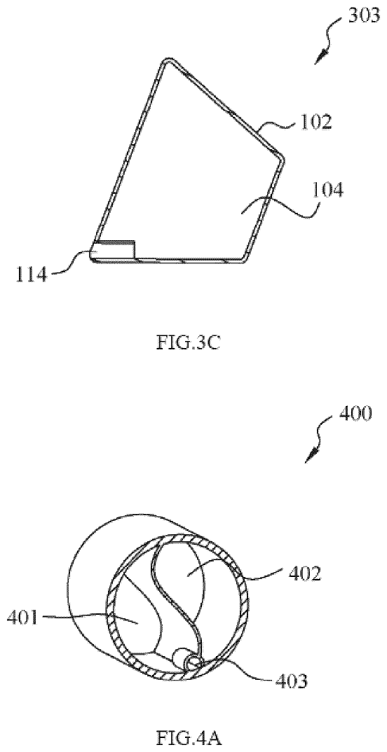

FIG. 3A is a front view of a silencing unit 301 according to a third embodiment of the present application. The similarities between the silencing unit 301 shown in FIG. 3A and the silencing unit 100 shown in FIGS. 1A-1B will not be described in detail again. The differences are that a main body 102 of the silencing unit 301 shown in FIG. 3A is cuboid-shaped, a cavity 104 (not shown) therein is also cuboid-shaped, and the cross section of the drain channel 114 is rectangular.

FIG. 3B is a front view of a silencing unit 302 according to a fourth embodiment of the present application. The similarities between the silencing unit 302 shown in FIG. 3B and the silencing unit 100 shown in FIGS. 1A-1B will not be described in detail again. The differences are that the cross section of a main body 102 of the silencing unit 302 shown in FIG. 3B is orthohexagonal, a cavity 104 (not shown) therein is also orthohexagonal, and the cross section of the drain channel 114 is fan-shaped.

FIG. 3C is a cross-sectional view of a silencing unit 303 according to a fifth embodiment of the present application along a length direction. The similarities between the silencing unit 303 shown in FIG. 3C and the silencing unit 100 shown in FIGS. 1A-1B will not be described in detail again. The difference is that a main body 102 of the silencing unit 303 shown in FIG. 3C is in a shape of an irregular pattern.

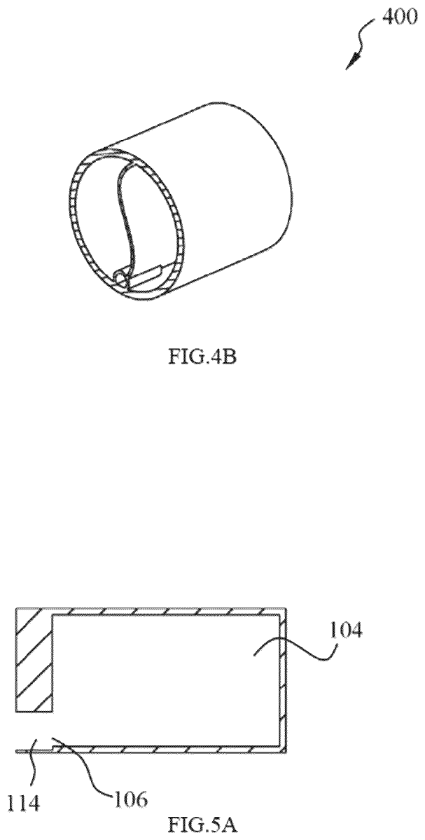

FIGS. 4A-4B are partial cross-sectional views of a silencing unit 400 according to a sixth embodiment of the present application. The similarities between the silencing unit 400 shown in FIGS. 4A-4B and the silencing unit 100 shown in FIGS. 1A-1B will not be described in detail again. The difference is that the silencing unit 400 includes two independent cavities, namely a first cavity 401 and a second cavity 402. The silencing unit 400 also includes a drain channel 403. The drain channel 403 communicates with the first cavity 401 and the second cavity 402, respectively. Therefore, liquid in the first cavity 401 and the second cavity 402 can also flow out of the first cavity 401 and the second cavity 402 through the drain channel 403.

It should be noted that in the above embodiments, the main body 102, the cavity 104 and the drain channel 114 can be arranged in any shape, and regardless of the shapes of the main body 102, the cavity 104 and the drain channel 114, the bottom of the drain channel 114 is flush with the bottom of the cavity 104, thereby facilitating the draining of the liquid from the cavity 104.

FIG. 5A is a cross-sectional view of a silencing unit according to a seventh embodiment of the present application along a length direction. The difference between the cross-sectional view of the silencing unit shown in FIG. 5A and the cross-sectional view of the silencing unit 100 shown in FIG. 1B is that in the silencing unit shown in FIG. 5A, the bottom of a cavity 104 is higher than the bottom of a drain channel 114.

FIG. 5B is a cross-sectional view of a silencing unit according to an eighth embodiment of the present application along a length direction. The difference between the cross-sectional view of the silencing unit shown in FIG. 5B and the cross-sectional view of the silencing unit 100 shown in FIG. 1B is that in the silencing unit shown in FIG. 5B, the bottom of the drain channel 114 is arranged in an inclined manner, and the bottom close to the free end is lower than the bottom close to the drain outlet 106, so that the bottom of the cavity 104 is higher than the bottom of the drain channel 114. Such arrangement manner helps the liquid present in the drain channel 114 to be drained quickly.

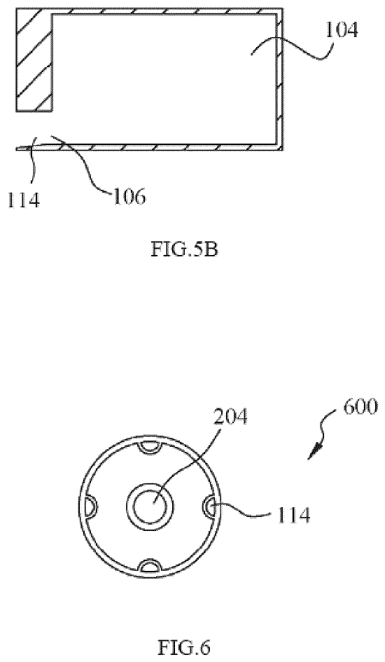

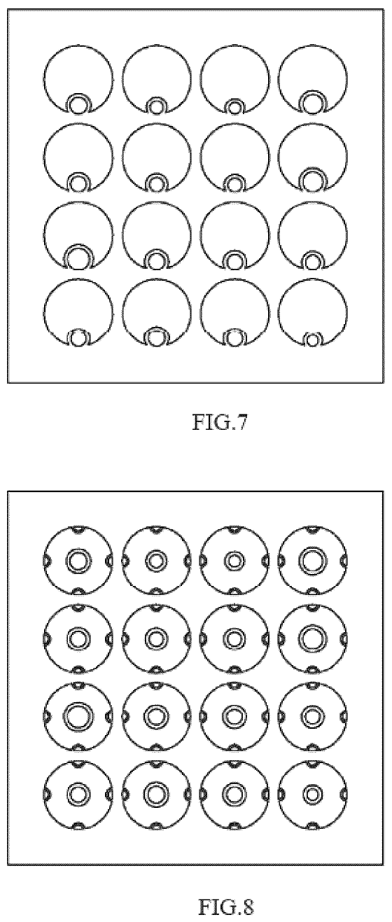

FIG. 6 is a front view of a silencing unit 600 according to a ninth embodiment of the present application. The similarities between the silencing unit 600 shown in FIG. 6 and the silencing unit 200 shown in FIGS. 2A-2B will not be described in detail again. The difference is that the silencing unit 600 shown in FIG. 6 includes four drain channels 114. The four drain channels 114 are evenly arranged along a circumferential direction, and are disposed so that when the silencing unit 600 rotates by 90° along the circumferential direction, the bottom of one of the four drain channels 114 is flush with the bottom of the cavity 104. Such arrangement can make the disposition of the silencing unit 600 more diversified, and an installer may choose one of the drain channels 114 to be arranged at the bottom.

FIG. 7 is a perspective view of a silencing structure composed of a silencing unit 100 shown in FIG. 1A. As shown in FIG. 7, the silencing structure includes sixteen silencing units 100. The sixteen silencing units 100 are arrayed in four rows and four columns, and a drain channel 114 of each of the silencing units 100 is located at the bottom.

FIG. 8 is a front view of a silencing structure composed of a silencing unit 600 shown in FIG. 6. As shown in FIG. 8, the silencing structure includes sixteen silencing units 600. The sixteen silencing units 600 are arrayed in four rows and four columns, and one drain channel 114 in each of the silencing units 600 is located at the bottom. Compared with the silencing structure shown in FIG. 7, the arrangement of the silencing structure shown in FIG. 8 has better flexibility. Specifically, in an environment where silencing is required, the silencing structure shown in FIG. 8 may be disposed in the shown orientation, or be rotated by 90°, both of which can have the functions of silencing and draining the liquid simultaneously.

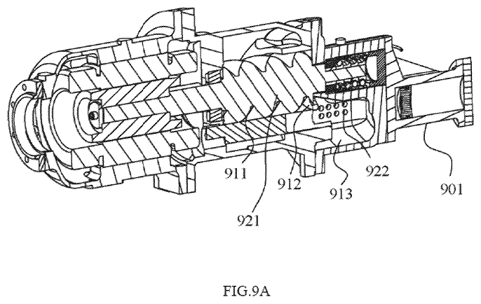

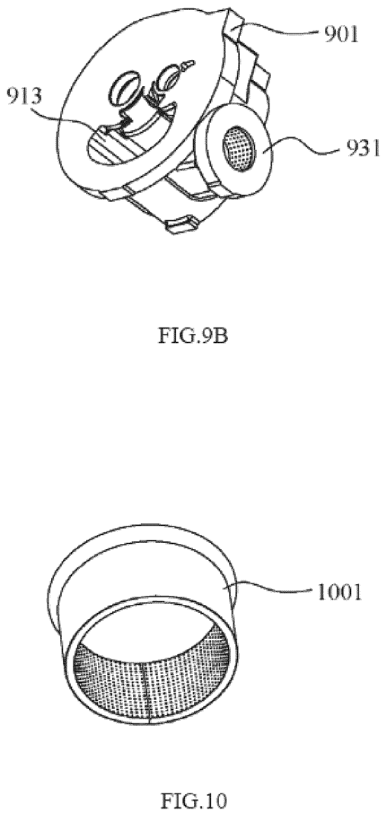

FIG. 9A is an example of a cutaway perspective view of a screw compressor using a silencing structure of the present application. FIG. 9B is another example of a cutaway perspective view of a screw compressor using a silencing structure of the present application. As shown in FIG. 9A, the screw compressor includes a screw compressor housing 901. The screw compressor housing 901 defines a rotor cavity 911 and a drain cavity 913. The rotor cavity 911 and the drain cavity 913 communicate with each other through a communication port 912. Specifically, a pair of rotors is arranged in the rotor cavity 911. The pair of rotors includes a male rotor 921 and a female rotor (not shown). A compression cavity (not shown) is formed between the male rotor 921 and the female rotor, which is formed by surrounding by tooth surfaces of the male rotor 921 and the female rotor. The compression cavity can be in fluid communication with the drain cavity 913 through the communication port 912. When the screw compressor is in operation, gas enters the compression cavity between the male rotor 921 and the female rotor from an inlet of the screw compressor. As the male rotor 921 and the female rotor rotate, the compression cavity will gradually decrease and move toward the direction of the communication port 912. When the compression cavity moves to be in fluid communication with the communication port 912, compressed gas in the compression cavity flows into the drain cavity 913 through the communication port 912. A part of the screw compressor housing 901 forms the silencing structure. Specifically, an inlet (i.e., the free end) of the drain channel 114 of the silencing unit is arranged on the wall surface of the drain cavity 913. The wall surface of the drain cavity 913 is substantially planar. The extending directions (i.e., the first direction) of the drain channel 114 and the cavity 104 of the silencing unit are perpendicular to the wall surface. Thus, the silencing structure can eliminate the sound in the drain cavity 913.

As shown in FIG. 9B, the screw compressor housing 901 also defines an exhaust pipe 931. The inlet (i.e., the free end) of the drain channel 114 of the silencing unit is arranged on the wall surface of the exhaust pipe 931. The wall surface of the exhaust pipe 931 is substantially circular (i.e., non-planar). Extending directions (i.e., the first direction) of the drain channel 114 and the cavity 104 of the silencing unit are perpendicular to a tangent line at the wall surface where the drain channel and the cavity are disposed. In other words, the extending directions (i.e., the first direction) of the drain channel 114 and the cavity 104 of the silencing unit are arranged along a radial direction of the exhaust pipe 931. Accordingly, the silencing structure can eliminate the sound passing through the exhaust pipe 931.

FIG. 10 is a perspective view of a wind guide ring 1001 using the silencing structure of the present application. As shown in FIG. 10, the wind guide ring 1001 is substantially ring-shaped, and can be connected to a fan (not shown). A part of the wind guide ring 1001 forms the silencing structure. Specifically, an inlet (i.e., the free end) of the drain channel 114 of the silencing unit is arranged on the inner wall of the wind guide ring 1001. A wall surface of an inner wall of the wind guide ring 1001 is substantially circular (i.e., non-planar). Extending directions (i.e., the first direction) of the drain channel 114 and the cavity 104 of the silencing unit are perpendicular to a tangent line at the wall surface where the drain channel and the cavity are disposed. In other words, the extending directions (i.e., the first direction) of the drain channel 114 and the cavity 104 of the silencing unit are arranged along a radial direction of the wind guide ring 1001. Thus, the silencing structure can eliminate the sound passing through the wind guide ring 1001. Meanwhile, liquid such as rainwater and condensed water entering each silencing unit can be automatically drained in time, so as to maintain the stability of the silencing effect of the silencing structure. In addition, cleaning recovery is also facilitated with regard to dust accumulated in the silencing unit during long-term use.

Although the present application only shows two embodiments in which the wall surfaces in the silencing structures are planar and circular, those skilled in the art can understand that no matter whether the wall surface is planar or non-planar, the silencing structure of the present application can be used.

It should also be noted that although in the embodiments shown in FIGS. 8-10 of the present application, structures of the silencing units in the silencing structure are the same, in the embodiment shown in FIG. 7, sizes of the drain channels 114 of the silencing units are different. More specifically, diameters of the drain channels 114 are different. In addition, it can be understood that in other embodiments, structures of the silencing units in the silencing structure may also be different, e.g., the volumes of the cavities 104 of the drain channels 114 or the sizes of the drain channels 114 are different (e.g., different in length). The volume of the cavity 104 and the size of the drain channel 114 in the silencing unit can eliminate sound with a certain hertz (i.e., a certain frequency), and the silencing units with different sizes can eliminate sound with multiple hertz, thereby expanding the scope of silencing.

It should also be noted that although in each embodiment of the present application, the extending direction (i.e., the first direction) of the drain channel 114 and the cavity 104 of the silencing unit is perpendicular to the wall surface, but in other embodiments, however, the extending direction (i.e., the first direction) of the drain channel 114 and the cavity 104 of the silencing unit is disposed at an acute angle with respect to the wall surface.

While only some of the features of the present application have been illustrated and described herein, various modifications and changes will occur to those skilled in the art. It is therefore to be understood that the appended claims are intended to cover all such modifications and changes that fall within the true spirit of the present application.

1. A silencing unit comprising:
a main body comprising a cavity and a drain outlet, wherein the drain outlet is arranged on a side wall of the main body and communicates with the cavity; and
a neck arranged on a side portion of the main body and connected to the main body, wherein the neck comprises a drain channel,
wherein the drain channel communicates with the cavity through the drain outlet, and a bottom of the cavity is not lower than a bottom of the drain channel.

2. The silencing unit of claim 1, wherein:
the drain channel and the cavity extend along a first direction.

3. The silencing unit of claim 1, wherein:
the bottom of the drain channel is inclined.

4. The silencing unit of claim 1, wherein:
the bottom of the cavity is flush with the bottom of the drain channel.

5. The silencing unit of claim 1, wherein:
the bottom of the cavity is higher than the bottom of the drain channel.

6. The silencing unit of claim 1, wherein the silencing unit further comprises:
a communication neck arranged on the side portion of the main body, wherein the communication neck is connected to the main body, the communication neck comprises a communication channel, and the communication channel communicates with the cavity.

7. The silencing unit of claim 6, wherein:
the communication channel, the drain channel, and the cavity extend along a first direction.

8. A silencing structure, comprising:
a wall comprising a wall surface; and
at least one silencing unit of claim 1, wherein an inlet of the drain channel is arranged on the wall surface.

9. The silencing structure of claim 8, wherein:
the silencing structure comprises drain channels of at least two silencing units, and volumes of cavities of the drain channels of the at least two silencing units or sizes of the drain channels are different.

10. The silencing structure of claim 8, wherein:
the wall surface is non-planar, and extending directions the cavity and the drain channel of the at least one silencing unit are perpendicular to a tangent line at the wall surface where the cavity and the drain channel are disposed.
